(19) United States
(12) Patent Application Publication
(10) Pub. No.: US 2007/0205058 A1
(43) Pub. Date: Sep. 6, 2007

(54) Elevator inspection system

(76) Inventors: Jose Caballero, Madrid (ES); Andre Monzon Simon, Madrid (ES); Fernando Del Rio Sanz, Madrid (ES)

Correspondence Address: Lisa A Bongiovi;Otis Elevator Company, 10 Farm Springs, Farmington, CT, 06032, US

(21) Appl. No.: 10/590,299

(22) PCT Filed: Mar. 31, 2004
(86) PCT No.: PCT/IB04/00983

§ 371 Date: Aug. 23, 2006

(51) Int. Cl. B66B 1/02; B66B 5/26

(52) U.S. Cl. 187/306; 187/378

(57) ABSTRACT

An elevator system comprises a hoistway; an elevator car (12) arranged to move vertically within the hoistway; a plurality of landings opening into said hoistway; and a pit (22) located below a lowermost landing (18). The elevator system further comprises an engineer interface, e.g. a key switch, located at or near the lowermost landing arranged to generate a control signal for moving the elevator car to a predetermined parking position above the lowermost landing thereby allowing access to the pit.

This invention relates to a system for enhancing the safety of an elevator engineer needing to access the pit of an elevator—particularly, but not exclusively, in elevator systems in which the pit is of a reduced depth as compared to a standard depth.

As part of routine inspection and maintenance operations, it is common for an elevator engineer to need to access the elevator pit at the bottom of the hoistway. In many elevator systems the pit is of sufficient dimensions that there is space for a person to crouch in it even when the elevator car is resting on the fully compressed buffers. For example, in the EN81 standard a minimum space of 0.5×0.6×1.0 metres is defined. Additionally, there are further standards and practices which require a minimum vertical clearance between elements mounted on the underside of the elevator car and elements mounted in the pit.

In spite of the above, there are elevator systems which have a shallower pit than specified above or even have no pit at all. It is generally desirable to install elevators with the minimum possible depth of pit consistent with safety requirements since this would minimise building costs.

It is an object of the present invention to enhance the safety of an engineer needing to access the pit in any elevator system but particularly those in which the pit is relatively shallow.

When viewed from a first aspect the present invention provides an elevator system comprising a hoistway; an elevator car arranged to move vertically within the hoistway; a plurality of landings opening into said hoistway; and a pit located below a lowermost landing, the elevator system further comprising an engineer interface located at or near the lowermost landing arranged to generate a control signal for moving the elevator car to a predetermined parking position above the lowermost landing thereby allowing access to said pit.

Thus is it will be seen by those skilled in the art that in accordance with the invention, an engineer may, by means of the interface, move the elevator car up from the bottom landing to a special parking position to allow him or her to access the elevator pit.

Preferably the elevator comprises a locking arrangement to prevent movement of the car once it is in the parking position. In preferred embodiments logical locking means are provided. For example a controller for the elevator may be configured to prevent movement of the car when in the parking position until the above-mentioned engineer interface is operated.

Additionally or alternatively in preferred embodiments means, preferably accessible from beneath the car, are provided for locking the car to the guide rail. Once in the pit, the engineer may then lock the car in position physically or at least physically prevent further downward movement of the car. The invention therefore essentially provides a “virtual pit” by allowing the engineer a safe degree of working space even where this is not provided physically by the dimensions of the pit.

When viewed from a second aspect the invention provides a method of operating an elevator system having a hoistway; an elevator car arranged to move vertically within the hoistway; a plurality of landings opening into the hoistway and a pit located at the bottom of the hoistway beneath a lowermost landing; the method comprising moving the elevator car to the lowermost landing, generating a control signal and moving said car up to a predetermined parking position above the lowermost landing in response to said control signal.

When viewed from a third aspect the invention provides software for operating an elevator system comprising logic adapted to receive a first control signal from an engineer interface; logic for generating a second control signal to an elevator machine to move said car upwardly; logic for receiving a signal indicating that the elevator car has reached a predetermined parking position; and logic for generating a control signal to said elevator machine to halt further movement of the car until a further control signal is received from said interface.

The engineer interface may take any convenient form although it is preferred that the form and/or location of the interface is such as to prevent operation by unauthorised persons. In preferred embodiments the interface comprises a key switch which may for example be located adjacent the car call button at the lowermost landing. Alternatively, the switch may be located in a cabinet at or near the lowermost landing.

It will be appreciated that in accordance with the invention an engineer requiring to access the pit may simply call the elevator to the lowermost landing, check that no-one is inside the car and then operate the kev switch or other interface in order to send the elevator to the parking position. After this the engineer will open the landing doors and lock them in their open position as is known per se in the art. The engineer may then operate the pit entry switch located in the hoistway but accessible from the lowermost landing. This is a safety cut-out switch which disrupts electrical power to the elevator machine, thereby preventing further operation of the elevator. The engineer may then enter the pit and optionally physically secure the elevator car to the guide rails. It will be appreciated that in accordance with the invention all of the operations required to enter the pit safely may be carried out from the lowermost landing without having to access the elevator controller which is typically located in the machine room or adjacent to the uppermost landing in machine room-less layouts.

Alternative possibilities for the engineer interface include a code entry keypad, a swipe card, a magnetic identity card, a smart card reader or indeed any other device which allows the identity and/or authority of the user to be ascertained. A preferred embodiment of the present invention will now be described, by way of example only, with reference to the accompanying drawings in which:

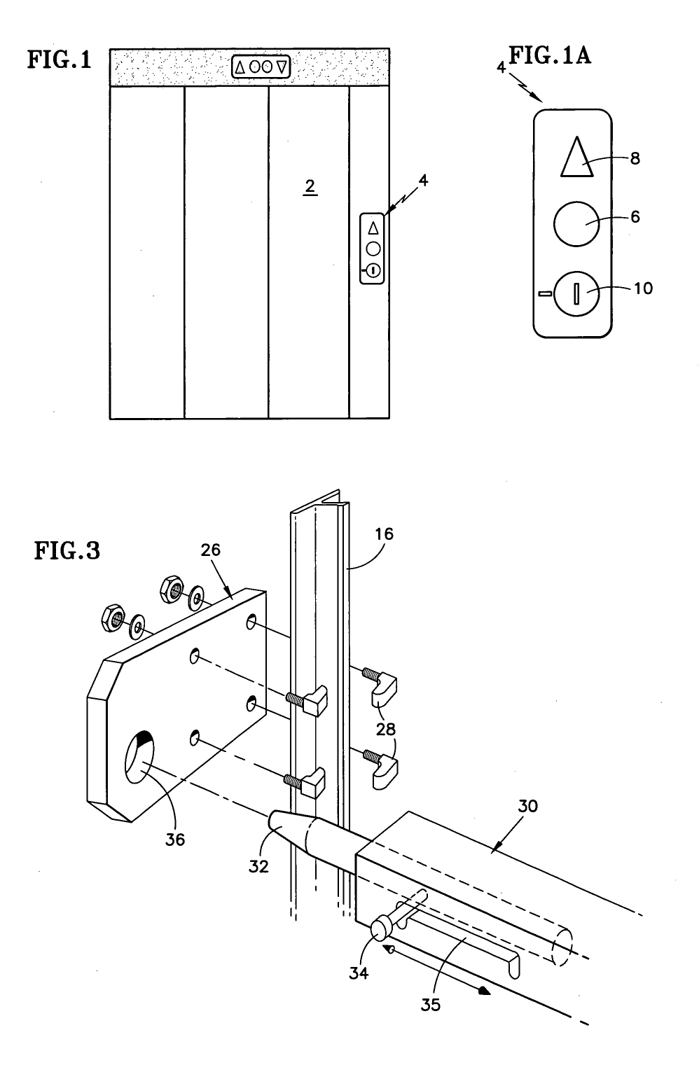

FIG. 1 is a front elevation of a lowermost elevator landing including a close-up view of the switch panel;

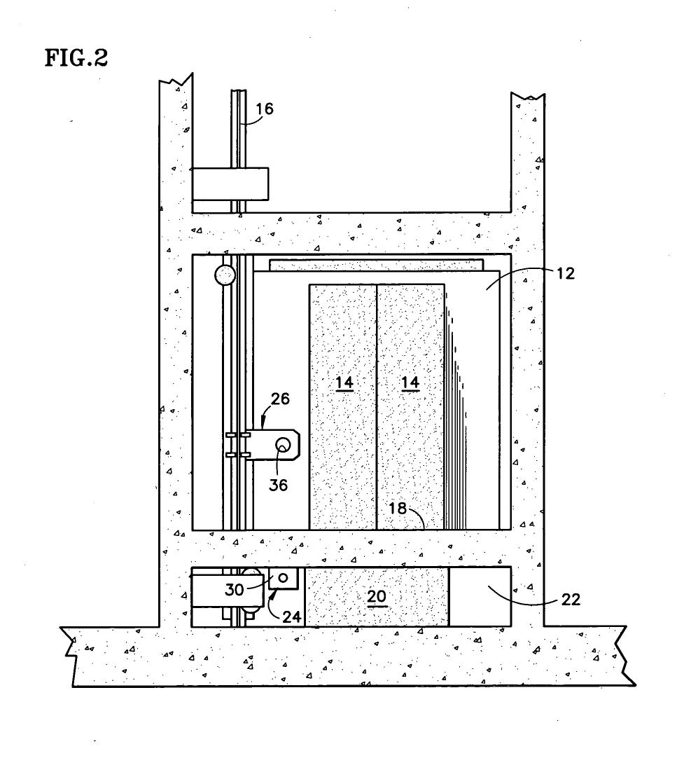

FIG. 2 is a cutaway view of the elevator shaft showing the car at the lowermost landing;

FIG. 3 is a detailed view showing the car safety bolt arrangement;

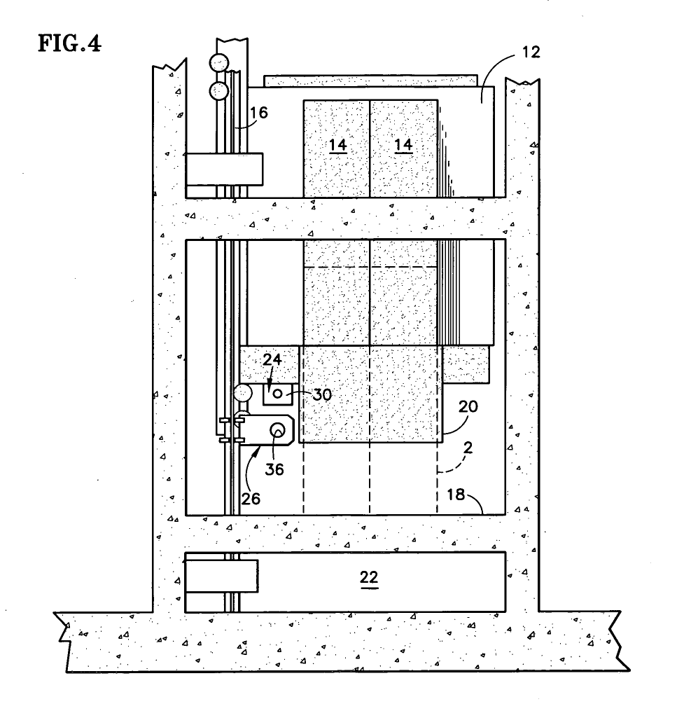

FIG. 4 shows the car 12 during its decent from one of the higher landings;

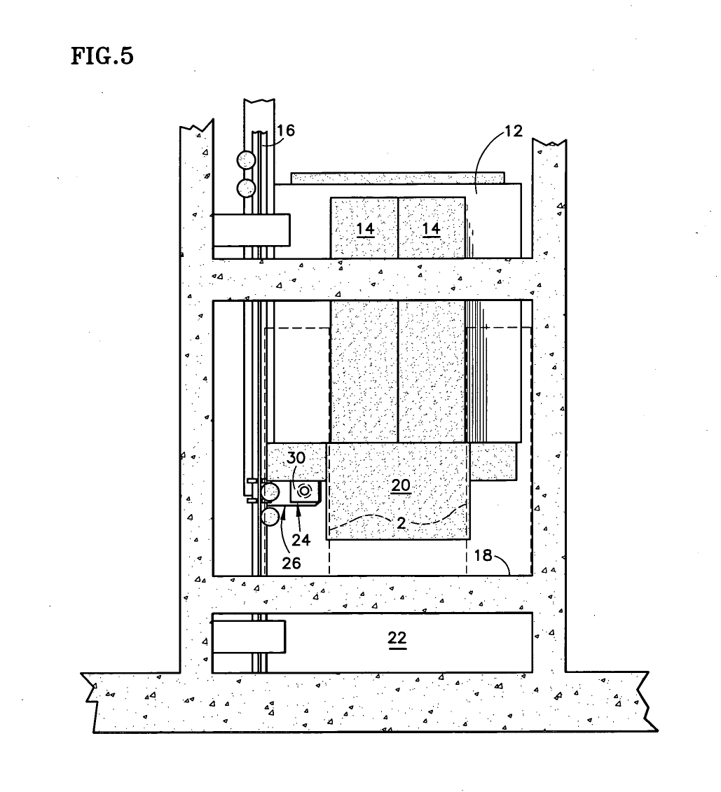

FIG. 5 is a view similar to FIGS. 2 and 4 showing the car in the pit-access parking position.

Turning firstly to FIG. 1 there may be seen a standard set of hallway doors 2 at a lowermost landing to the right of which is provided a control panel 4 seen more clearly in the detail portion of FIG. 1. The control panel 4 comprises a car call button 6 and a called car indicator light 8 as is well known in the art. The control panel 4 is, however, also provided with a key switch 10 for initiating a pit access operation as will be described hereinafter.

The hoistway and car are shown in the cutaway view of FIG. 2. The car 12 is closed by a pair of sliding doors 14 as is well known in the art. The car 12 is supported for vertical movement on a pair of guide rails 16 which, in this embodiment, are both on the left hand side of the car in a so called rucksack configuration. FIG. 2 shows the car 12 aligned with the lowermost landing 18. A toe guard or apron 20 extends down from the bottom of the car 12 into the pit 22 defined below the lowermost landing 18. As may be appreciated schematically from FIG. 2 the pit 22 is relatively shallow compared to the height of the car 12 and does not provide adequate space safely to accommodate a person crouching in it.

Also mounted to the underneath of the car 12 is a safety bolt mechanism 24 which is described in greater detail below with reference to FIG. 3. A corresponding locking plate 26 is mounted to one of the guide rails 16 so as to be in horizontal alignment with the locking bolt mechanism 24. It will be appreciated, however, that in the position shown in FIG. 2 the bolt mechanism and locking plate are vertically misaligned.

FIG. 3 shows greater detail of the safety bolt mechanism 24 and locking plate 26. The locking plate 26 is clamped against the flat, outwardly facing surface of the T-section guide rail 16 by four clamps 28. The safety bolt mechanism 24 comprises a bolt housing 30 fixed to the underside of the car 12 and a bolt member 32 slidingly received in the housing 30. A perpendicular handle 34 on the bolt moves within a broad U-shaped slot 35 so as to enable the bolt member 32 to be locked in both its retracted and deployed positions. Although shown exploded for the sake of clarity in FIG. 3, in practice the safety bolt housing 30 and the locking plate 26 are sufficiently close to one another that when the correct vertical alignment is achieved, the tapered end of the bolt member 32 enters a corresponding hole 36 in the locking plate 26 when moved from the retracted to the deployed position. This acts physically to lock the car to the guide rail thereby preventing vertical movement of the car.

The pit access operation will now be described with additional reference to FIGS. 4 and 5. During normal operation of the elevator the key switch 10 located on the button panel 4 of the lowermost landing is in the position shown in FIG. 1 with its slot vertical. However, when an engineer requires access to the elevator pit for maintenance he or she will firstly call the elevator using the call button 6 in the normal way. FIG. 4 shows the car during its descent from an upper landing. Once the car 12 arrives at the lowermost landing 18 the engineer first ensures that all passengers have left the car. The engineer will then insert the required key into the key switch 10 and turn it to a maintenance position as indicated by the adjacent marking. This generates a signal to the elevator controller to energise the elevator machine so as slowly to raise the car 12.

Once the car 12 has reached the special predetermined parking position shown in FIG. 5, position sensors (not shown) in the hoistway send a signal to the elevator controller which in turn stops the machine and therefore stops movement of the car 12. Many suitable position sensors are known in the art for example magnetically based sensors.

Once the car 12 is in this position, the engineer will then open and lock the sliding hallway doors 2 in a manner well known in the art. he or she may then reach from the landing 18 into the hoistway and operate the handle 34 of the safety bolt mechanism 24 to move it from its retracted position to its deployed position where it passes through the aperture 36 in the locking plate 26. This physically prevents any unwanted movement of the car 12. Once the car is locked in position in this way, the engineer can safely enter the pit 22 from the landing 18 in order to carry out any required inspection of maintenance. It will be appreciated that however shallow the pit 22, the height of the car 12 above the lowermost landing 18 in the parking position shown in FIG. 5 is sufficiently high to allow the engineer easy entry and exit from the pit 22 for inspection and maintenance despite the apron 20. It also allows the underside of the car 12 itself to be inspected. The arrangement therefore provides a “virtual” pit.

One the engineer has fin-shed the inspection or maintenance, he or she may then climb out of the pit 22, release the safety bolt 24, close the landing doors 2 and return the key switch 10 to its normal operating position. This sends a further signal to the controller to allow normal operation of the elevator to resume.

Although not shown in this embodiment, a pit entry switch could also be provided in the hoistway as an additional safety measure to prevent movement of the car. The switch would be accessible from the landing to allow the engineer to reach into the hoistway and press the switch before climbing into the pit.

1. An elevator system comprising:
a hoistway;
an elevator car arranged to move vertically within the hoistway;
a plurality of landings opening into said hoistway; and
a pit located below a lowermost landing (18), the elevator system further comprising an engineer interface located at or near the lowermost landing arranged to generate a control signal for moving the elevator car to a predetermined parking position above the lowermost landing thereby allowing access to said pit.

2. An elevator system as claimed in claim 1 comprising locking means for locking the car to a guide rail.

3. An elevator system as claimed in claim 2 wherein said locking means are accessible from beneath the car.

4. An elevator system as claimed in claim 1 wherein said engineer interface comprises a key switch.

5. An elevator system as claimed in claim 1 wherein said engineer interface is located adjacent an elevator call button at the lowermost landing.

6. An elevator system as claimed in claim 1 comprising logical means for preventing movement of said car when in said parking position.

7. A method of operating an elevator system having a hoistway; an elevator car arranged to move vertically within the hoistway; a plurality of landings opening into the hoistway and a pit located at the bottom of the hoistway beneath a lowermost landing; the method comprising moving the elevator car to the lowermost landing, generating a control signal and moving said car up to a predetermined parking position above the lowermost landing in response to said control signal.

8. Software for operating an elevator system comprising logic adapted to receive a first control signal from an engineer interface; logic for generating a second control signal to an elevator machine to move said car upwardly; logic for receiving a signal indicating that the elevator car has reached a predetermined parking position; and logic for generating a control signal to said elevator machine to halt further movement of the car until a further control signal is received from said interface.
